(19) United States
(12) Patent Application Publication
(10) Pub. No.: US 2025/0122788 A1
(43) Pub. Date: Apr. 17, 2025

(54) METHOD FOR EVALUATING GEOLOGICAL STORAGE AMOUNT OF CO2 IN FRACTURED-VUGGY CARBONATE RESERVOIR

(71) Applicant: TONGJI UNIVERSITY, Shanghai (CN)

(72) Inventors: Jizhou TANG, Shanghai (CN); Zhuo ZHANG, Shanghai (CN); Siwei MENG, Shanghai (CN); Xiaoyu LU, Shanghai (CN); Jianhua GENG, Shanghai (CN)

(73) Assignee: TONGJI UNIVERSITY, Shanghai (CN)

(21) Appl. No.: 18/636,643

(22) Filed: Apr. 16, 2024

(30) Foreign Application Priority Data
Oct. 17, 2023 (CN) 2023113481973

(51) Int. Cl. E21B 43/16; E21B 43/25

(52) U.S. Cl. CPC E21B 43/164; E21B 43/168; E21B 43/255

(57) ABSTRACT

The present disclosure provides a method for evaluating a geological storage amount of carbon dioxide (CO₂) in a fractured-vuggy carbonate reservoir, including: performing image identification on a three-dimensional scanned image of a rock sample to obtain identified rock information; inputting the identified rock information to a computational fluid dynamics-based numerical simulator for constructing a fractured-vuggy rock structure model, and obtaining geometric topological information of the rock sample based on the fractured-vuggy rock structure model; inputting relevant parameters of the rock sample and the geometric topological information to a multi-scale multi-phase flow numerical model for numerical simulation of multi-phase flow migration of CO₂ in models of different scales and obtaining a multi-scale numerical simulation result; and calculating a multi-scale CO₂ storage efficiency based on the multi-scale numerical simulation result. The present disclosure may effectively evaluate and predict the storage capability of CO₂ in fractured-vuggy carbonate rock.

### CROSS REFERENCE TO RELATED APPLICATION

This patent application claims the benefit and priority of Chinese Patent Application No. 2023113481973, filed with the China National Intellectual Property Administration on Oct. 17, 2023, the disclosure of which is incorporated by reference herein in its entirety as part of the present application.

### TECHNICAL FIELD

The present disclosure relates to the technical field of geological storage, and in particular, to a method for evaluating a geological storage amount of carbon dioxide (CO₂) in a fractured-vuggy carbonate reservoir.

### BACKGROUND

CO₂ is an important greenhouse gas. Reducing carbon emission has become a key measure for ameliorating the problems of climate change, ecological damage, unsustainable development, and the like. Carbon capture and storage (CCS), which involves storing CO₂ in a subsurface reservoir and preventing release thereof to the atmosphere, had been universally acknowledged by national governments as the most direct and effective method for reducing carbon emission in the 1990s. Common geological places for carrying out CCS include unextractable coal seams, depleted oil and gas reservoirs, and deep saline aquifers. Nearly 60% of global oil and gas reservoirs are buried in carbonate rocks. China possesses a wide distribution of carbonate sedimentary strata (about 3 million km²), which are characterized by great thickness and a fractured-vuggy structure advantageous for carbon storage. Therefore, evaluating the geological CO₂ storage capability of carbonate rocks after oil and gas depletion is of great significance.

At present, there are four primary trapping mechanisms for geological CO₂ storage (numbered (1)-(4) below), each of which can be categorized into physical storage mechanism and chemical storage mechanisms. The physical storage mechanisms mainly involves injecting and filling CO₂ into an available space in a geological reservoir for a short period. The physical storage trapping mechanisms include (1) forming entrapped structural trapping by utilizing the reservoir space and impermeable caprock above and (2) residual trapping under restraint by capillary forces of matrix pores. The chemical storage mechanism involves long-term consumption and storage of CO₂ by CO₂-water-rock geochemical reaction at a particular condition of temperature and pressure. The chemical storage trapping mechanisms include (3) dissolution trapping by contacting CO₂ with formation water and (4) residual oil and mineralization trapping by generating carbonate minerals after acidification. Evaluating the geological CO₂ storage capability requires calculation and prediction of a final storage amount. Currently, main evaluation means include the use of macro mathematical models and numerical simulations, and each of the two techniques has its own advantages and limitations. For example, the mathematical model lacks detailed consideration on a micro-scale physical storage mechanism and a long-term chemical storage mechanism. Therefore, it is possible to underestimate a final storage amount in a carbonate reservoir that has a complex fractured-vuggy structure and exhibits high mineralization reaction activity. While numerical simulation can model the CO₂ migration mechanism at the pore microscale and estimate the mineralization storage amount over longer periods, this technique not only suffers from slow computational efficiency when dealing with physical storage at actual geological scales, but also struggles to comprehensively consider on-site parameters and lacks detailed depiction of real geological features. On this basis, there is an urgent need for a method to evaluate the four geological trapping mechanisms mentioned above.

### SUMMARY

The present disclosure aims to solve most (if not all) of the technical problems existing in the related art.

For this purpose, the present disclosure provides a method that can efficiently and comprehensively evaluate the geological storage amount of CO₂ in a fractured-vuggy carbonate reservoir, and realize prediction and assessment based on the four geological trapping mechanisms for carbonate reservoirs.

To achieve the above purpose, a first aspect of the present disclosure provides a method for evaluating a geological storage amount of carbon dioxide (CO₂) in a fractured-vuggy carbonate reservoir, including the following steps: performing image identification on a three-dimensional scanned image of a rock sample to obtain identified rock information; inputting the identified rock information to a computational fluid dynamics-based numerical simulator for constructing a structure model of fractured-vuggy rock, and obtaining geometric topological information of the rock sample based on the structure model of fractured-vuggy rock; inputting relevant parameters of the rock sample and the geometric topological information to a multi-scale multi-phase flow numerical model for numerical simulation of multi-phase flow migration of CO₂ in models of different scales and obtaining a multi-scale numerical simulation result; and calculating a multi-scale CO₂ storage efficiency based on the multi-scale numerical simulation result.

The method for evaluating a geological storage amount of CO₂ in a fractured-vuggy carbonate reservoir in the embodiments of the present disclosure may also have the following additional technical features.

In an embodiment of the present disclosure, the rock sample includes a fractured-vuggy carbonate reservoir rock sample; and the relevant parameters of the rock sample include physical parameters of the fractured-vuggy carbonate reservoir and fluid property parameters of a fluid during geological storage.

In an embodiment of the present disclosure, the performing image identification on a three-dimensional scanned image of a rock sample to obtain identified rock information includes: converting the three-dimensional scanned image into a binary image, and reading a data matrix of the binary image; mapping the data matrix to a red, green, blue (RGB) color value matrix to obtain a first visualization result; and obtaining a final data matrix based on a result of comparison between the first visualization result and the three-dimensional scanned image in a topological geometry and a second visualization result of the fluid on the three-dimensional scanned image.

In an embodiment of the present disclosure, the converting the three-dimensional scanned image into a binary image includes: extruding a color channel of the three-dimensional scanned image by using a weighted average method to obtain a gray level; and comparing the gray level with a gray level threshold to obtain a binarized image based on a numerical comparison result.

In an embodiment of the present disclosure, the inputting relevant parameters of the rock sample and the geometric topological information to a multi-scale multi-phase flow numerical model for numerical simulation of multi-phase flow migration of CO₂ in models of different scales and obtaining a multi-scale numerical simulation result includes: solving a micro continuity equation based on a Darcy-Brinkman formula by a numerical simulation method to construct the multi-scale multi-phase flow numerical model; and inputting the physical property parameters, the fluid property parameters, and the geometric topological information to the multi-scale multi-phase flow numerical model for numerical simulation of multi-phase flow migration of CO₂ in the models of different scales and obtaining the multi-scale numerical simulation result of a saturation distribution of CO₂ after being injected.

In an embodiment of the present disclosure, the micro continuity equation includes single-phase and multi-phase micro continuity equations based on mass conservation and single-phase and multi-phase micro continuity equations based on momentum conservation; the numerical simulation method includes a finite volume method; and the multi-scale multi-phase flow numerical model includes a fluid volume method and an implicit Euler difference algorithm. In such embodiment, the method may further include: discretizing the single-phase and multi-phase micro continuity equations based on mass conservation using the finite volume method based on a volume average operator to obtain discretized data; discretizing a fluid domain into at least one control volume unit based on the fluid volume method, and describing a distribution of the fluid by calculating a volume fraction of a fluid phase in each control volume unit, where the volume fraction in each control volume unit represents a volume proportion of a particular fluid phase in the control volume unit; and expressing the discretized data as data in a semi-discrete form using the implicit Euler difference algorithm.

In an embodiment of the present disclosure, the calculating a multi-scale CO₂ storage efficiency based on the multi-scale numerical simulation result includes: obtaining a storage volume of CO₂ by means of the saturation distribution and calculating a fluid injection volume and a CO₂ storage efficiency based on the storage volume and a fluid volume conservation rule to obtain the multi-scale CO₂ storage efficiency.

In an embodiment of the present disclosure, the obtaining a storage volume of CO₂ by means of the saturation distribution and calculating a fluid injection volume and a CO₂ storage efficiency based on the storage volume and a fluid volume conservation rule to obtain the multi-scale CO₂ storage efficiency include: obtaining, by means of numerical simulation, a saturation distribution of CO₂ corresponding to each control volume unit, and obtaining the storage volume of CO₂ based on a first calculation formula; calculating a volume of injected CO₂ by a second calculation formula based on the fluid volume conservation rule; and based on the storage volume of CO₂ and the volume of injected CO₂, calculating the CO₂ storage efficiency by a third calculation formula.

In an embodiment of the present disclosure, the method further includes: evaluating a physical structural storage efficiency of CO₂ by using the multi-scale numerical simulation result and a macro mathematical model; evaluating a physical residual storage efficiency of CO₂ by an empirical model; evaluating a chemical dissolution storage efficiency of CO₂ by the empirical model; and evaluating a chemical mineralization storage efficiency of CO₂ by a numerical model.

In an embodiment of the present disclosure, the evaluating a physical structural storage efficiency of CO₂ by using the multi-scale numerical simulation result and a macro mathematical model includes: obtaining first fractured-vuggy carbonate reservoir parameters, where the first fractured-vuggy carbonate reservoir parameters include a geological reserve parameter and a development and production parameter of reservoir crude oil, a geological reserve parameter and a development and production parameter of reservoir natural gas, a three-dimensional volume engraving parameter of a fractured-vuggy body in the fractured-vuggy carbonate reservoir, and a hydraulic fracturing reservoir reformation parameter of an induced fracture in the fractured-vuggy carbonate reservoir; and inputting the first fractured-vuggy carbonate reservoir parameters and the CO₂ storage efficiency calculated based on a multi-scale simulation result to an analytical model improved based on an evaluation formula of Carbon storage Leadership Forum (CSLF) to evaluate a total structural storage amount of CO₂.

In an embodiment of the present disclosure, the evaluating a physical residual storage efficiency of CO₂ by an empirical model includes: obtaining second fractured-vuggy carbonate reservoir parameters, where the second fractured-vuggy carbonate reservoir parameters include a reservoir dimensional parameter of the fractured-vuggy carbonate reservoir, a volume proportion of carbonate rock immersed by water in a saturated state of CO₂, a carbonate reservoir porosity, and a CO₂ saturation range under a capillary hysteresis effect; calculating a volume of carbonate rock immersed by water in the saturated state of CO₂ using the volume proportion of carbonate rock immersed by water in the saturated state of CO₂ and the reservoir dimensional parameter; and inputting the volume of carbonate rock immersed by water in the saturated state of CO₂, the carbonate reservoir porosity, and the CO₂ saturation range under the capillary hysteresis effect to an empirical model of a residual storage experiment to evaluate a total residual storage amount of CO₂.

In an embodiment of the present disclosure, the evaluating a chemical dissolution storage efficiency of CO₂ by the empirical model includes: obtaining third fractured-vuggy carbonate reservoir parameters, where the third fractured-vuggy carbonate reservoir parameters include a molar solubility at which CO₂ reaches an equilibrium state when dissolved in crude oil, a relative molecular mass of CO₂, an initial crude oil saturation of the carbonate reservoir, a formation water density in the saturated state of CO₂, an average mass fraction of CO₂ in the saturated state in formation water, and a mass fraction and an average molecular weight of hydrocarbons;
substituting the molar solubility at which CO₂ reaches the equilibrium state when dissolved in crude oil and the relative molecular mass of CO₂ into an empirical model of a CO₂ dissolution storage experiment in carbonate reservoir residual oil to evaluate a total dissolution storage amount of CO₂ in reservoir residual oil; and inputting the initial crude oil saturation of the carbonate reservoir, the formation water density in the saturated state of CO₂, the average mass fraction of CO₂ in the saturated state in formation water, and the mass fraction and the average molecular weight of hydrocarbons to an empirical model of a CO₂ dissolution storage experiment in carbonate reservoir formation water to evaluate a total dissolution storage amount of CO₂ in reservoir formation water.

In an embodiment of the present disclosure, the evaluating a chemical mineralization storage efficiency of CO₂ by a numerical model includes: obtaining fourth fractured-vuggy carbonate reservoir parameters, where the fourth fractured-vuggy carbonate reservoir parameters include a fractured-vuggy carbonate reservoir salinity, a component proportion of mineral composition of fractured-vuggy carbonate rock, a reservoir solution ion concentration, a CO₂ injection rate during carbon storage, and a time of CO₂ mineralization storage; and inputting the fourth fractured-vuggy carbonate reservoir parameters and the reservoir dimensional parameter to a simulator with a hydrogeochemical module to calculate a final CO₂ mineralization storage amount by numerical simulation.

The method for evaluating a geological storage amount of CO₂ in a fractured-vuggy carbonate reservoir in the embodiments of the present disclosure is applied to evaluate and predict the CO₂ storage capability in fractured-vuggy carbonate rocks, and this is of great significance for studying and implementing the CCS technique.

Additional aspects and advantages of the present disclosure is provided in the following descriptions.

### BRIEF DESCRIPTION OF THE DRAWINGS

Embodiments of the present disclosure now will be described more fully hereinafter with reference to the accompanying drawings in which some but not all embodiments are shown.

FIG. 1 is a flowchart of a method for evaluating a geological storage amount of CO₂ in a fractured-vuggy carbonate reservoir provided in an embodiment of the present disclosure;

FIG. 2 is a diagram illustrating a technical route of evaluating a geological storage amount of CO₂ in a fractured-vuggy carbonate reservoir provided in an embodiment of the present disclosure;

FIG. 3A illustrates a three-dimensional scanned image of a sample including fracture and hole information provided in an embodiment of the present disclosure;

FIG. 3B illustrates a three-dimensional scanned image of a sample including fracture and hole information provided in an embodiment of the present disclosure;

FIG. 4A illustrates a modeled image of a fractured-vuggy rock structure based on three-dimensional scanned image identification provided in an embodiment of the present disclosure;

FIG. 4B illustrates a modeled image of a fractured-vuggy rock structure based on three-dimensional scanned image identification provided in an embodiment of the present disclosure;

FIG. 5A is a diagram illustrating a physical storage efficiency of CO₂ obtained based on a multi-scale multi-phase flow numerical simulation result provided in an embodiment of the present disclosure;

FIG. 5B is a diagram illustrating a physical storage efficiency of CO₂ obtained based on a multi-scale multi-phase flow numerical simulation result provided in an embodiment of the present disclosure;

FIG. 5C is a diagram illustrating a physical storage efficiency of CO₂ obtained based on a multi-scale multi-phase flow numerical simulation result provided in an embodiment of the present disclosure;

FIG. 6 is a diagram illustrating contributions of different reservoir spaces in structural storage obtained based on a physical storage efficiency of CO₂ provided in an embodiment of the present disclosure;

FIG. 7 is a diagram illustrating contributions of formation water and residual oil in dissolution storage obtained based on an experimental empirical model provided in an embodiment of the present disclosure; and

FIG. 8 is a diagram illustrating evaluating contributions of different geological CO₂ trapping mechanisms in a fractured-vuggy carbonate reservoir by a simultaneous numerical model and a macro mathematical model provided in an embodiment of the present disclosure.

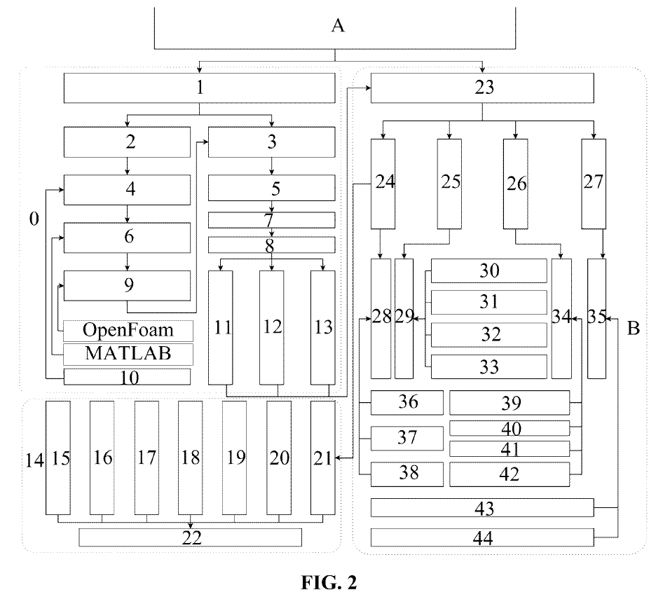

Numeral references in FIG. 2:
A: Method for evaluating geological storage amount of CO₂ in fractured-vuggy carbonate reservoir
B: Calculate CO₂ storage amounts under different mechanism by simultaneous numerical module and mathematical model
0: Calculate physical storage efficiency of CO₂ based on numerical simulation
1 Method of calculating physical storage efficiency of CO₂ in fractured-vuggy carbonate reservoir based on scanned image identification and multi-scale numerical simulation of rock
2 Model a fractured-vuggy structure of rock based on three-dimensional scanned image identification
3 Calculate a physical storage efficiency of CO₂ based on a multi-scale multi-phase flow numerical simulation result
4 Three-dimensional scanned image of a rock sample having fracture and hole information
5 Finite volume method based on a Darcy-Brinkman formula
6 Convert into a gray-scale image, read a data matrix, and set a double precision floating point format
7 Physical property parameters (porosity and permeability) of the reservoir
8 Fluid property parameters (density and viscosity)
9 Map into an RGB mode for visualization, save as an Excel file, and adjust to a model input file
10 CT scanning
11 Multi-phase flow numerical simulation on pore scale
12 Multi-phase flow numerical simulation on Darcy scale
13 Multi-phase flow numerical simulation on reservoir scale
14 Evaluate contributions of different mechanisms
15 Structural storage amount in crude oil space
16 Structural storage amount in natural gas space
17 Structural storage amount in fractured-vuggy body space
18 Residual storage amount in carbonate reservoir
19 Dissolution storage amount in residual oil
20 Dissolution storage amount in formulation water
21 Mineralization storage amount in carbonate reservoir
22 Total geological storage amount of CO₂ in fractured-vuggy carbonate rock
23 Method of evaluating geological storage mechanism of CO₂ in fractured-vuggy carbonate reservoir by simultaneous numerical model and macro mathematical model
24 Residual storage evaluation module
25 Structural storage evaluation module
26 Dissolution storage evaluation module
27 Mineralization storage evaluation module
28 Experimental empirical model
29 Improved CSLF evaluation formula
30 Geological reserve parameter and development and production parameter of reservoir crude oil
31 Geological reserve parameter and development and production parameter of reservoir natural gas
32 Three-dimensional volume engraving parameter of the fractured-vuggy body of the reservoir
33 Hydraulic fracturing reservoir reformation parameter of the reservoir
34 Experimental empirical model
35 Hydrogeochemical numerical simulation
36 Reservoir dimensional parameter
37 Volume proportion of carbonate rock immersed by water in a saturated state of CO₂
38 CO₂ saturation range under capillary hysteresis effect
39 Molar solubility at which CO₂ reaches an equilibrium state when dissolved in crude oil,
40 Relative molecular mass of CO₂
41 Formation water density in the saturated state of CO₂
42 Average mass fraction of CO₂ in the saturated state in formation water
43 Carbonate reservoir salinity, solution ion concentration, and each component proportion in a mineral composition of rock
44 CO₂ injection rate and time of CO₂ mineralization storage

### DETAILED DESCRIPTION OF THE EMBODIMENTS

It should be noted that embodiments in the present disclosure or features in the embodiments may be combined with one another without conflict. The present disclosure will be described in detail below with reference to the drawings and the embodiments.

To make persons skilled in the art better understand the present disclosure, the following clearly and completely describes the technical solutions in the embodiments of the present disclosure with reference to the accompanying drawings in the embodiments of the present disclosure. Apparently, the described embodiments are merely some rather than all of the embodiments of the present disclosure. All other embodiments obtained by persons of ordinary skill in the art based on the embodiments of the present disclosure without creative efforts shall fall within the scope of protection of the present disclosure.

A method for evaluating a geological storage amount of CO₂ in a fractured-vuggy carbonate reservoir provided in an embodiment of the present disclosure is described below with reference to the drawings.

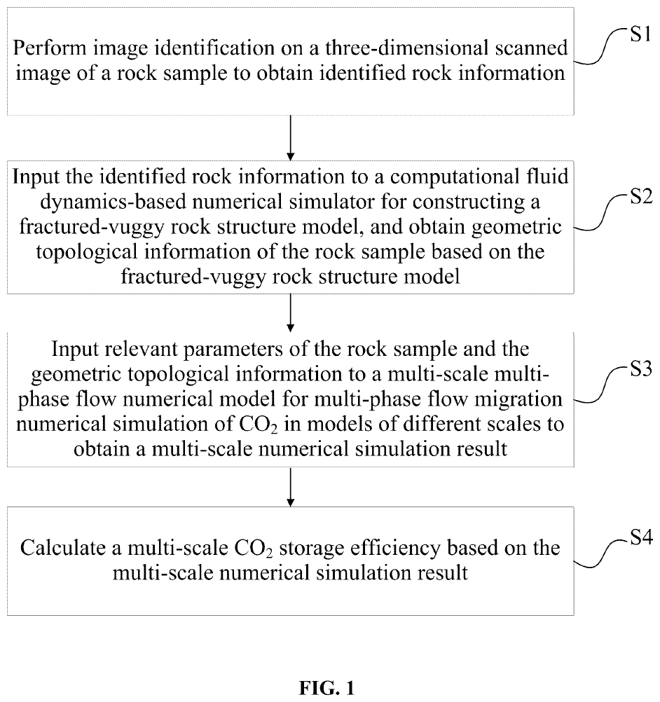

FIG. 1 is a flowchart of a method for evaluating a geological storage amount of CO₂ in a fractured-vuggy carbonate reservoir provided in an embodiment of the present disclosure.

As shown in FIG. 1 and FIG. 2, the method includes but is not limited to the following steps:

In a first step S1, image identification is performed on a three-dimensional scanned image of a rock sample to obtain identified rock information.

In one embodiment of the present disclosure, a three-dimensional scanned image of a fractured-vuggy carbonate reservoir rock sample including fracture and hole information is acquired.

The rock sample in the present embodiment is fractured-vuggy carbonate reservoir rock, and the three-dimensional scanned image may be a computer tomography (CT) scanned or electron microscope scanned image that can display fracture and hole information.

The three-dimensional scanned image is converted into a binary image using a compiler, and a data matrix of the binary image is read. A data format is then changed into a double precision floating point number, and data is saved as an Excel file.

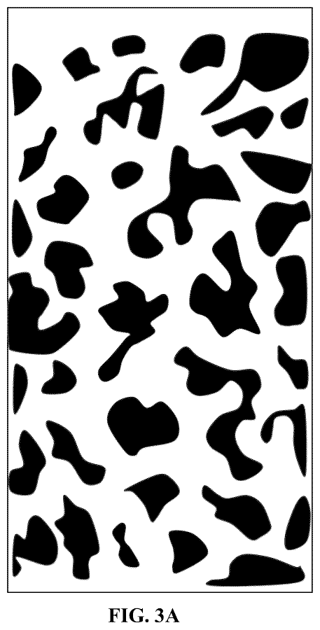

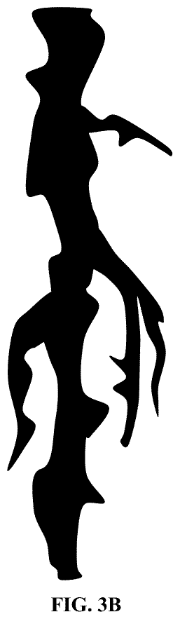

Specifically, the three-dimensional scanned image is converted into the binary image using the compiler. As shown in FIGS. 3A-B, the data matrix of the binary image is read, and the data format is then changed into the double precision floating point number, and data is saved as an Excel file.

Binarization includes the following steps: (1) image identification and graying: the compiler decodes the scanned image into a matrix, and matrix valves represent channel values of RGB colors. The channels of the three colors are extruded to gray levels of 0-255 by using a weighted average method. (2) Binary transform: a threshold is set, when the gray level is below the threshold, it is changed to 0; and when the gray level is above the threshold, it is changed to 255. Thus, the binarized image is obtained.

A formula used in the weighted average method is as follows:

G(x)=0.2989 R+0.5870 G+0.1140 B;

where G(x) is a gray level after changing by the weighted average method; R represents a red channel value of the image before graying; G represents a green channel value of the image before graying; and B represents a red channel value of the image before graying.

In one embodiment of the present disclosure, the data matrix is mapped, by the compiler, into an RGB color value matrix to be visualized, with a red component representing a discontinuous space and a blue component representing a continuous rock matrix. Whether the visualized image and the three-dimensional scanned image are consistent in topological geometry is inspected while confirming that there is sufficient flow channel for a fluid flowing into one end of the image to flow out of the other end of the image. A final data matrix of the visualized image may be saved as an Excel file for fractured-vuggy carbonate reservoir modeling.

If a size of the visualized image is M*N, a matrix of M*N*3 is established after the visualized image is mapped to the RGB color value matrix, and the value of 255 of the gray level is substituted into the red component, and 0 is substituted into the blue component.

If a size of the three-dimensional scanned image is a*b, to keep the visualized image consistent with the three-dimensional image in topological geometry, the image is firstly converted into ab*1 and then into a*b.

In a second step S2, the identified rock information is input to a computational fluid dynamics-based numerical simulator for constructing a fractured-vuggy rock structure model, and geometric topological information of the rock sample is obtained based on the fractured-vuggy rock structure model.

Specifically, the Excel file for modeling is input to a boundary condition directory file of a computing example of the computational fluid dynamics-based numerical simulator, and a geometry size of the computing example is adjusted to a sample size.

Inputting to the boundary condition directory file of the computing example of the computational fluid dynamics-based numerical simulator is implemented by substituting replacing all the values of 0 and 255 with values of physical properties corresponding to the discontinuous space and the continuous rock matrix, respectively.

The compiler includes but is not limited to MATLAB; the three-dimensional scanned image includes but is not limited to being obtained by CT scanning; and the computational fluid dynamics-based numerical simulator but is not limited to OpenFOAM.

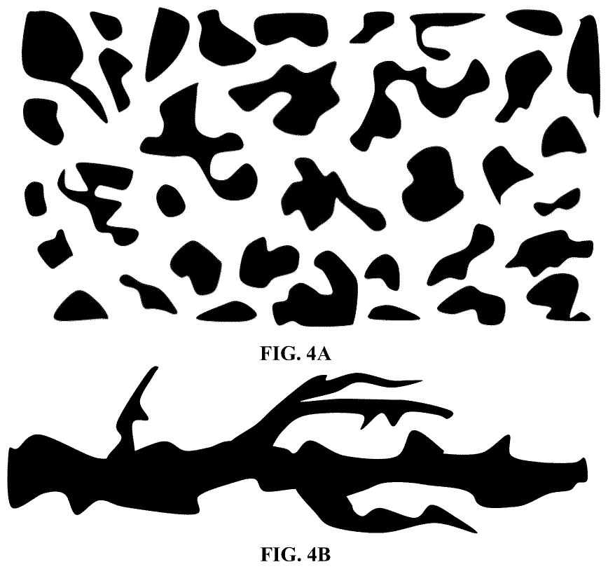

Modeling of the fractured-vuggy rock structure utilizing three-dimensional scanned image identification in the embodiment of the present disclosure is as shown in FIGS. 4A-B. The geometric topological information of holes and fractures in fractured-vuggy carbonate rock is obtained and may then be combined with other necessary input parameters for carrying out multi-scale multi-phase flow numerical simulation.

In a third step S3, relevant parameters of the rock sample and the geometric topological information are input to a multi-scale multi-phase flow numerical model for numerical simulation of multi-phase flow migration of CO₂ in models of different scales and obtaining a multi-scale numerical simulation result.

In one embodiment of the present disclosure, the physical property parameters of the carbonate reservoir are obtained for physical modeling of reservoir rock; fluid property parameters of a fluid during geological storage are obtained; and the Excel file for modeling is imported to the multi-scale multi-phase flow numerical model, and the fluid property parameters and the physical property parameters of the reservoir are input.

Further, after the Excel file and the parameters for modeling are imported, the numerical simulation of multi-phase flow migration of CO₂ in the models of different scales is performed by a multi-phase flow numerical model based on a Darcy-Brinkman formula, obtaining a saturation distribution of CO₂ after being injected. Specifically, the following steps are included:

The multi-phase flow numerical model is to solve a micro continuity equation (single-phase and multi-phase micro continuity equations based on mass conservation and single-phase and multi-phase micro continuity equations based on momentum conservation) based on the Darcy-Brinkman formula by a numerical simulation method;

where the Darcy-Brinkman formula is as follows:

$$∇ \cdot ( - K ∇ P ) + μ ( ∇ \cdot u ) = ρ g ;$$

where K represents a permeability of the rock; P represents a pressure field; μ represents a viscosity of CO₂; ρ represents a density of CO₂; and g represents the acceleration of gravity.

The single-phase micro continuity equation based on mass conservation is as follows:

$$∇ \cdot {v}_{i} = 0 ;$$

The multi-phase micro continuity equation based on mass conservation is as follows:

$${ρ}_{l} ( {v}_{l} - w ) \cdot {n}_{l g} = {ρ}_{g} ( {v}_{g} - w ) \cdot {n}_{l g} ;$$

The single-phase micro continuity equation based on momentum conservation is as follows:

$$- ∇ {p}_{i} + {ρ}_{i} g + ∇ \cdot {S}_{i} = 0 , {S}_{i} = {μ}_{i} ( ∇ {v}_{i} + ∇ {{v}_{i}}^{T} ) ;$$

The multi-phase micro continuity equation based on momentum conservation is as follows:

$$[ {p}_{l} I - {S}_{l} ] \cdot {n}_{lg} = [ {p}_{g} I - {S}_{g} ] \cdot {n}_{lg} + σκ {n}_{lg} , κ = ∇ \cdot {n}_{lg} ;$$

where vᵢ represents the ith phase (i=l representing a liquid phase, g representing a gas phase), and ρᵢ and pᵢ represent a density and a pressure of the phase, respectively; g represents a gravity vector; Sᵢ and μᵢ represent a viscous stress tensor and a viscosity of the ith phase; w represents an interfacial velocity; nᵢⱼ represents a normal vector pointing to interfaces i and j of a non-wetting phase; I represents a unit tensor; σ represents a two-phase interfacial tension; and K represents an interfacial curvature. In case of no phase change, for a multi-phase system, vᵢ=v_{g}=w.

The numerical simulation method includes but is not limited to a finite volume method, and by the finite volume method, the single-phase and multi-phase micro continuity equations based on mass conservation in S21 are discretized using the finite volume method based on a volume average operator:

$${\overline{β}}_{i} = ϕ {a}_{i} {\overline{β}}_{i}^{i} = \frac{1}{V} {\int }_{{V}_{i}} {β}_{i} dV , {\overline{β}}_{i}^{i} = \frac{1}{{V}_{i}} {\int }_{{V}_{i}} {β}_{i} dV , \\ ϕ = ( {V}_{l} + {V}_{g} ) / V , {a}_{l} = {V}_{l} / ( {V}_{l} + {V}_{g} ) ;$$

where V represents a discrete volume; βᵢ represents a continuously differentiable function related to the ith (i=l, g) phase; ϕ represents a porosity field; aₗ represents a saturation field; and β̅ᵢⁱ represents a phase average operator.

A pressure and a velocity of a single phase are expressed as follows:

$$\overline{p} = {a}_{l} {\overline{p}}_{l}^{l} + {a}_{g} {\overline{p}}_{g}^{g} , \overline{v} = ϕ [ {a}_{l} {\overline{v}}_{l}^{l} + {a}_{g} {\overline{v}}_{g}^{g} ] ;$$

where p̅ and v̅ represent a single field pressure based on the Darcy-Brinkman method and a Darcy velocity weighted sum.

The multi-phase flow numerical model further includes a fluid volume method, by which a fluid domain is discretized into one or more control volume units and a distribution of the fluid is described by tracking a volume fraction of a fluid phase in each control volume unit. The volume fraction in each control volume unit represents a volume proportion of a particular fluid phase (e.g., the liquid phase or the gas phase) in the control volume unit.

The multi-phase flow numerical model further includes an implicit Euler difference algorithm. A momentum equation is discretized by utilizing the finite volume method and expressed in a semi-discrete form using an implicit Euler difference format:

$${V}_{cell} ( \frac{{ρ}^{k + 1} {v}_{P}^{k + 1} - {ρ}^{k} {v}_{P}^{k}}{δ t} ) = - {a}_{P}^{′} {v}_{P}^{k + 1} + {\sum }_{NP} {a}_{NP}^{′} {v}_{NP}^{k + 1} - ∇ p + ρ g + {F}_{c} - {K}_{fs} {v}_{P}^{k + 1} ;$$

where V_{cell} represents a unit volume; δt represents a time step; the subscript P represents a value of a unit center; a′_{NP} represents an influencing factor for adjacent control volumes affected by a convective flux and a diffusion flux that flow through a unit surface; and K_{fs} represents a momentum exchanged between a fluid and a solid.

In a fourth step S4, a multi-scale CO₂ storage efficiency is calculated based on the multi-scale numerical simulation result.

Specifically, a storage volume of CO₂ is obtained by means of the saturation distribution, and a fluid injection volume and a CO₂ storage efficiency are then calculated based on a fluid volume conservation rule to obtain the multi-scale CO₂ storage efficiency.

Further, a CO₂ saturation distribution corresponding to each unit may be obtained by means of numerical simulation, and the storage volume of CO₂ is obtained by the following formula:

$${V}_{co 2} = sum ( {a}_{co 2} {V}_{c} / {N}_{p} ) , {N}_{p} = ( {x}_{c} + 1 ) ( {y}_{c} + 1 ) ( {z}_{c} + 1 ) ;$$

where V_{co2} represents the storage volume of CO₂; a_{co2} represents a unit saturation; V_{c} represents a volume of rock; Nₚ represents a number of lattice points of a rock discrete body; x_{c}, y_{c}, and z_{c} represent unit numbers in xyz directions of the rock, respectively.

According to the fluid volume conservation rule, a volume of CO₂ injected each time may be obtained:

$${V}_{a} = ( 2 {I}_{x} + ( {I}_{y 2} - {I}_{y 1} ) ) {I}_{z} Ut ;$$

where Vₐ represents the volume of CO₂ injected; Iₓ, I_{y}, and I_{z} represent lengths of an injection port in the xyz directions; U represents an injection rate; and t represents a time of simulated injection.

Then, a calculation formula for the CO₂ storage efficiency is as follows:

$$η = {V}_{co 2} / {V}_{a} * 100 \% .$$

It will be understood that the physical property parameters of the carbonate reservoir includes a permeability range, a porosity range, a temperature range, and a pressure range, and may be obtained from field geological exploration data. The fluid includes CO₂, formation water, and residual oil. The fluid properties include a density and a viscosity of the fluid, and may be calculated from the temperature and pressure ranges of the reservoir in combination with physical models. The different scales include a pore scale, a Darcy scale, and a reservoir scale.

It will be understood that the physical model for calculating the density of CO₂ includes but is not limited to the Van der Waals equation, and the physical model for calculating the viscosity of CO₂ includes but is not limited to a molecular kinetic theory model.

The method for evaluating a geological storage amount of CO₂ in a fractured-vuggy carbonate reservoir provided in the embodiment of the present disclosure includes: performing image identification on the three-dimensional scanned image of the fractured-vuggy carbonate rock sample including the fracture and hole information, and importing the identified rock information to the computational fluid dynamics-based numerical simulator for fractured-vuggy structure modeling of the rock; obtaining the physical property parameters of the carbonate reservoir and the fluid property parameters of the fluid during geological storage; and inputting the parameters to the multi-scale multi-phase flow numerical model to obtain the saturation distribution of CO₂ in the models of difference scales after the completion of injection and the multi-scale CO₂ storage efficiency. Prediction and evaluation can be efficiently and comprehensively carried out for four geological trapping mechanisms in the carbonate reservoir.

To implement the above embodiment, the present disclosure further includes: evaluate a physical structural storage efficiency of CO₂ by using the multi-scale numerical simulation result and a macro mathematical model; evaluate a physical residual storage efficiency of CO₂ by an empirical model; evaluate a chemical dissolution storage efficiency of CO₂ by the empirical model; and evaluate a chemical mineralization storage efficiency of CO₂ by a numerical model, as shown in FIG. 2.

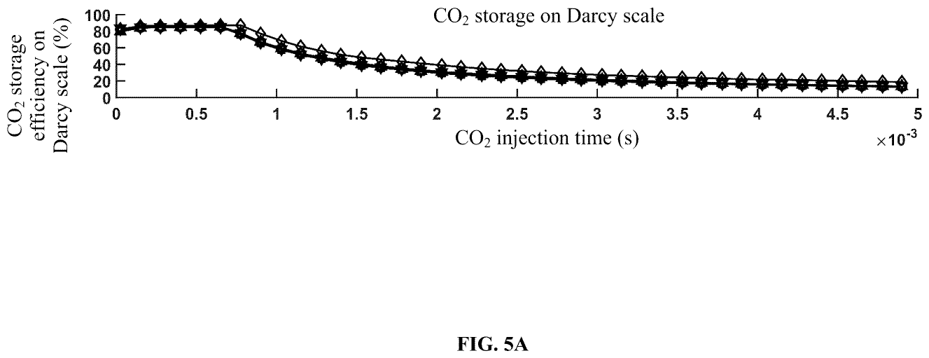

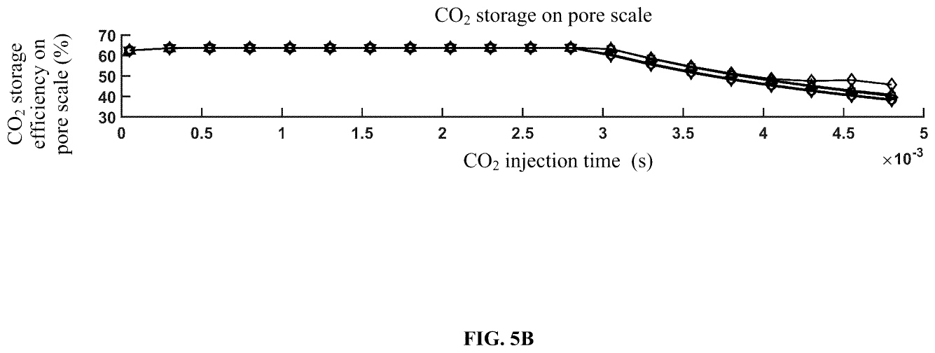

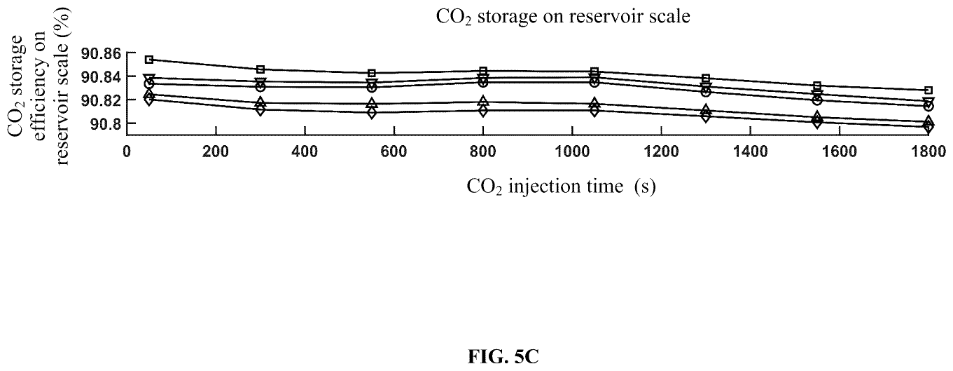

FIGS. 5A-C are diagram illustrating a physical storage efficiency of CO₂ obtained based on a multi-scale multi-phase flow numerical simulation result, as shown in FIGS. 5A-C.

In one embodiment of the present disclosure, a structural storage evaluation module is configured to evaluate the physical structural storage efficiency of CO₂ by using the multi-scale numerical simulation result and the macro mathematical model.

For a specified fractured-vuggy carbonate reservoir, a geological reserve parameter and a development and production parameter of reservoir crude oil and a geological reserve parameter and a development and production parameter of reservoir natural gas are obtained; for a fractured-vuggy body of the specified fractured-vuggy carbonate reservoir, a three-dimensional volume engraving parameter is obtained; and for an induced fracture in the specified fractured-vuggy carbonate reservoir, a hydraulic fracturing reservoir reformation parameter is obtained.

All the fractured-vuggy carbonate reservoir parameters are substituted into an analytical model improved based on an evaluation formula of Carbon storage Leadership Forum (CSLF), and the storage efficiency in the multi-scale simulation result is substituted into the analytical model to evaluate a total structural storage amount of CO₂.

The analytical model improved based on the evaluation formula of CSLF is as follows:

$${V}_{CO 2 , CR}^{S , F} = ( \frac{{R}_{oil} {N}_{00 IP}}{{ρ}_{oil} {B}_{oil}} - {V}_{IW} + {V}_{PW} + {R}_{gas} {N}_{0 GIP} ( 1 - {F}_{IG} ) ( \frac{{P}_{s} {Z}_{r} {T}_{r}}{{P}_{r} {Z}_{s} {T}_{s}} ) ) {C}_{H} + {V}_{DC} {C}_{P} + {V}_{IF} {C}_{D} ;$$

where V_{CO2,CR}^{S,F} represents a structural storage volume of CO₂ in the carbonate reservoir; ρₒᵢₗ represents a crude oil density on the ground; Bₒᵢₗ represents a crude oil volume coefficient; Rₒᵢₗ and R_{gas} represent recovery ratios of crude oil and natural gas, respectively; N_{OOIP} and N_{OGIP} represent a geological reserve of crude oil and a geological reserve of natural gas, respectively; F_{IG} represents a percentage of an injected gas; Z represents a reservoir gas compression coefficient; P and T represent a pressure and a temperature, respectively; subscripts r and s represent reservoir and surface conditions; V_{IW} and V_{PW} represent a total volume of injected water for development and a total volume of water produced from development, respectively; V_{DC} and V_{IF} represent a total apparent volume of the fractured-vuggy body and a total volume of a fracturing reformed fracture, respectively; and C_{H}, C_{P}, and C_{D} represent the CO₂ storage efficiencies on the reservoir scale, the pore scale, and a fracture scale, respectively.

The geological reserve parameter of reservoir crude oil includes the geological reserve of crude oil, the crude oil density, and the crude oil volume coefficient; the development and production parameter of reservoir crude oil includes the recovery ratio of crude oil, the total volume of injected water for development, and the total volume of water produced from development; the geological reserve of reservoir natural gas includes the geological reserve of the original natural gas; the development and production parameter of reservoir natural gas includes the recovery ratio of natural gas, the percentage of the injected gas, the reservoir gas compression coefficient, a surface temperature, a surface pressure, and a surface gas compression coefficient; the three-dimensional volume engraving parameter of the fractured-vuggy body in the carbonate reservoir is the total apparent volume of the fractured-vuggy body; and the hydraulic fracturing reservoir reformation parameter of the fractured-vuggy carbonate reservoir is the total volume of the fracturing reformed fracture.

The geological reserve parameter and the development and production parameter of reservoir crude oil and the geological reserve parameter and the development and production parameter of reservoir natural gas can all be obtained directly from or calculated from the field geological exploration data and development and production information; the three-dimensional volume engraving parameter of the fractured-vuggy body in the reservoir may be obtained by a three-dimensional volume engraving method; and the hydraulic fracturing reservoir reformation parameter of the fractured-vuggy carbonate reservoir may be obtained by early-stage fracturing simulation or microseismic inversion.

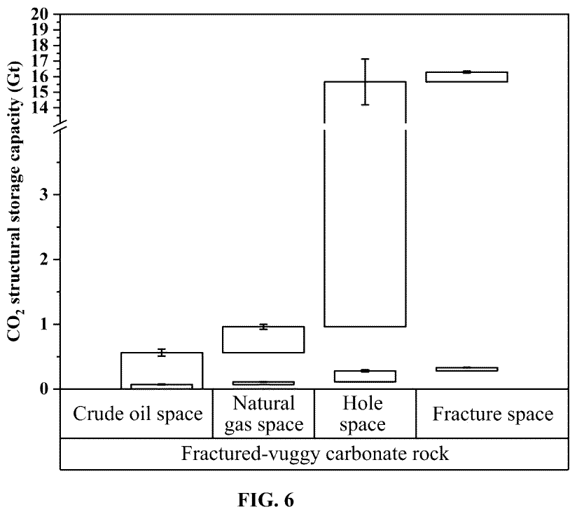

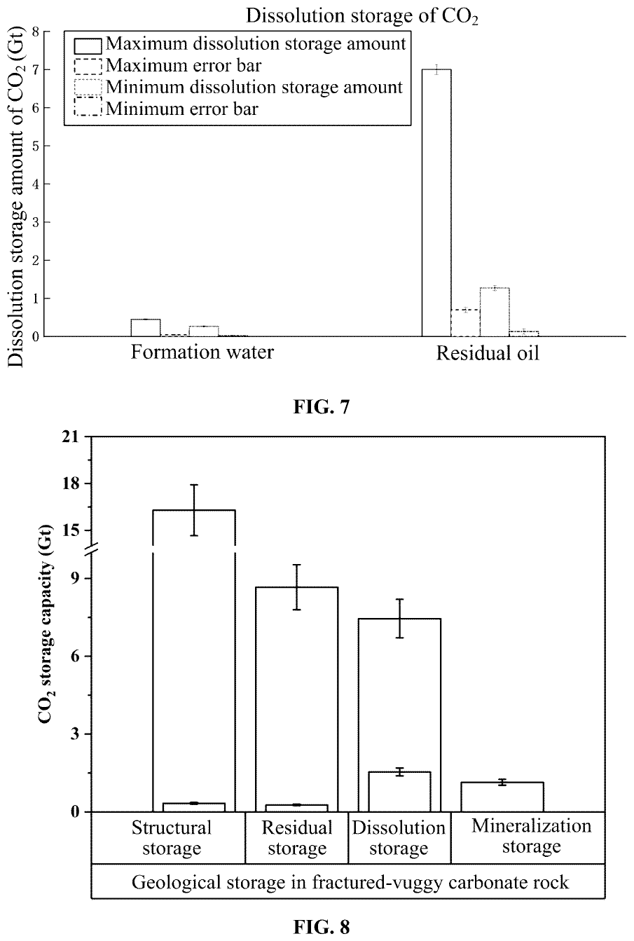

Further, FIG. 6 is a diagram illustrating contributions of different reservoir spaces in structural storage obtained based on a physical storage efficiency of CO₂; FIG. 7 is a diagram illustrating contributions of formation water and residual oil in dissolution storage obtained based on an experimental empirical model; and FIG. 8 is a diagram illustrating evaluating contributions of different geological CO₂ trapping mechanisms in a fractured-vuggy carbonate reservoir by a simultaneous numerical model and a macro mathematical model, as shown in FIG. 6, FIG. 7, and FIG. 8.

In one embodiment of the present disclosure, a residual storage evaluation module is configured to directly evaluate the physical residual storage of CO₂ by using the empirical model.

For the specified fractured-vuggy carbonate reservoir, a reservoir dimensional parameter, a volume proportion of carbonate rock immersed by water in a saturated state of CO₂, and a CO₂ saturation range under a capillary hysteresis effect are obtained.

A volume of carbonate rock immersed by water in the saturated state of CO₂ is calculated using the volume proportion of carbonate rock immersed by water in the saturated state of CO₂ and the reservoir dimensional parameter.

The volume of carbonate rock immersed by water in the saturated state of CO₂, the carbonate reservoir porosity, and the CO₂ saturation range under the capillary hysteresis effect are input to an empirical model of a residual storage experiment to evaluate a total residual storage amount of CO₂.

The approach for calculating the physical residual storage volume of CO₂ is an empirical model of Juanes experiment:

$${V}_{CO 2}^{R} = Δ {V}_{trap} \times ϕ \times {S}_{CO 2 t} ;$$

where ΔVₜᵣₐₚ represents the volume of carbonate rock immersed by water in the saturated state of CO₂; and S_{CO2t} represents the CO₂ saturation range under the capillary hysteresis effect.

The reservoir dimensional parameter includes a length, a width, and a thickness of the reservoir, which may be obtained from the field geological exploration data; and both of the volume of carbonate rock immersed by water in the saturated state of CO₂ and the CO₂ saturation range under the capillary hysteresis effect may be obtained by an indoor carbonate rock CO₂ immersion experiment or an existing literature.

In one embodiment of the present disclosure, a dissolution storage evaluation module is configured to directly evaluate the chemical storage of CO₂ by using the empirical model.

A molar solubility at which CO₂ reaches an equilibrium state when dissolved in crude oil, a relative molecular mass of CO₂, an initial crude oil saturation of the carbonate reservoir, a formation water density in the saturated state of CO₂, an average mass fraction of CO₂ in the saturated state in formation water, and a mass fraction and an average molecular weight of hydrocarbons are obtained.

The molar solubility at which CO₂ reaches the equilibrium state when dissolved in crude oil and the relative molecular mass of CO₂ are substituted into an empirical model of a CO₂ dissolution storage experiment in carbonate reservoir residual oil to evaluate a total dissolution storage amount of CO₂ in reservoir residual oil.

The initial crude oil saturation of the carbonate reservoir, the formation water density in the saturated state of CO₂, the average mass fraction of CO₂ in the saturated state in formation water, and the mass fraction and the average molecular weight of hydrocarbons are substituted into an empirical model of a CO₂ dissolution storage experiment in carbonate reservoir formation water to evaluate a total dissolution storage amount of CO₂ in reservoir formation water.

The approach for calculating a chemical dissolution storage amount of CO₂ is an empirical model of Xue Haifeng's experiment:

$${M}_{CO 2 oil , CR}^{D} = \frac{{N}_{00 IP}}{{ρ}_{oil}} \times {B}_{oil} \times ( 1 - {R}_{oil} ) \times {C}_{CO 2 oil}^{s} \times {m}_{CO 2}^{m} ;$$

where C_{CO2oil}^{s} represents the molar solubility at which CO₂ reaches the equilibrium state when dissolved in crude oil; and m_{CO2}^{m} represents the relative molecular mass of CO₂, 44 g/mol.

A calculation formula for the molar solubility at which CO₂ reaches the equilibrium state when dissolved in crude oil in the empirical model of Xue Haifeng experiment is as follows:

$${C}_{CO 2 oil}^{s} = \frac{{KP}_{r} {x}_{T} {ρ}_{oil}}{{M}_{T} f ( T ) + α {KP}_{r} {M}_{T} f ( T ) + {KP}_{r} {x}_{T} {ρ}_{oil} f ( T ) {V}_{ϕ}} ;$$

where K represents a reaction equilibrium constant; Pᵣ represents a reservoir pressure; x_{T} represents the mass fraction of hydrocarbons; M_{T} represents the average molecular weight of hydrocarbons; α and f(T) represent two coefficients related to a temperature; and V_{ϕ} represents an apparent molar volume of CO₂.

Calculation formulas for the reaction equilibrium constant, the two coefficients related to a temperature, and the apparent molar volume of CO₂ in the empirical model of Xue Haifeng's experiment are as follows:

$$K = exp ( 773.247 {( {T}_{r} - 273.15 )}^{- 1} - 18.5898 ) ;$$

$$α = 0.00008286 ( {T}_{r} - 273.15 ) - 0.7061 ;$$

$$f ( T ) = 0.97974 + 7.31378 \times {10}^{- 4} ( {T}_{r} - 273.15 ) + 7.8749 \times {10}^{- 7} {( {T}_{r} - 273.15 )}^{2} ;$$

$${V}_{ϕ} = 37.51 - 9.585 \times {10}^{- 2} ( {T}_{r} - 273.15 ) + 8.74 \times {10}^{- 4} {( {T}_{r} - 273.15 )}^{2} - 5.044 \times {10}^{- 7} {( {T}_{r} - 273.15 )}^{3} ;$$

where Tᵣ represents the reservoir temperature.

The molar solubility at which CO₂ reaches the equilibrium state when dissolved in crude oil, the formation water density in the saturated state of CO₂, and the average mass fraction of CO₂ in the saturated state in formation water may all be obtained by an indoor CO₂ immersion experiment or an experimental empirical formula; the relative molecular mass of CO₂ may be directly calculated from a relative atomic mass; and the initial crude oil saturation of the carbonate reservoir and the mass fraction and the average molecular weight of hydrocarbons may be directly obtained from the field geological exploration data.

In one embodiment of the present disclosure, a mineralization storage evaluation module is configured to predict the chemical mineralization storage of CO₂ by the numerical model.

Specifically, for the specified fractured-vuggy carbonate reservoir, a fractured-vuggy carbonate reservoir salinity, a component proportion of mineral composition of fractured-vuggy carbonate rock, and a reservoir solution ion concentration are obtained; a CO₂ injection rate during carbon storage and a required predicted time of CO₂ mineralization storage are obtained; and the fractured-vuggy carbonate reservoir salinity, the component proportion of mineral composition of fractured-vuggy carbonate rock, the reservoir solution ion concentration, the reservoir dimensional parameter, the CO₂ injection rate, and the time of CO₂ mineralization storage are substituted into a simulator with a hydrogeochemical module to obtain a final CO₂ mineralization storage amount by numerical simulation.

It will be understood that the simulator with the hydrogeochemical module includes but is not limited to TOUGHREACT.

A formula for the simulator with the hydrogeochemical module to calculate the chemical mineralization storage amount of CO₂ by numerical simulation is as follows:

$${M}_{CO 2 , CR}^{M} = \sum ( r \times {m}_{CO 2}^{m} \times 3.1536 \times {10}^{- 5} ) \times t ;$$

where r represents a mineral dissolution rate; and t represents a mineralization time.

The mineral dissolution rate is obtained by the following formula:

$$r = k ( T ) {A}_{T} {a}_{H +}^{n} {\vert [ {( \frac{Q}{K} )}^{μ} - 1 ] \vert}^{v} , k ( T ) = {k}_{25} exp [ \frac{- Ea}{R} ( \frac{1}{T} - \frac{1}{298.15} ) ]$$

where k(T) represents a reaction rate constant function regarding temperature T, and k₂₅ represents a reaction rate constant at 25° C.; Ea represents reaction activation energy; a_{H+}ⁿ represents an activity coefficient of H⁺; A_{T} represents a specific reaction surface area; Q represents reaction entropy; K represents an equilibrium constant of a mineral and water reaction; v represents a kinematic viscosity; and R represents a reaction constant.

It will be understood that the fractured-vuggy carbonate reservoir salinity and the reservoir solution ion concentration may be obtained by investigation of reservoir water quality; the component proportion of mineral composition of fractured-vuggy carbonate rock may be obtained by an X ray diffraction experiment; and the CO₂ injection rate and the time of CO₂ mineralization storage may be provided by construction parameters in a geological storage field.

The method for evaluating a geological storage amount of CO₂ in a fractured-vuggy carbonate reservoir provided in the embodiment of the present disclosure includes: perform image identification on the three-dimensional scanned image of the fractured-vuggy carbonate rock sample including the fracture and hole information, and import the identified rock information to the computational fluid dynamics-based numerical simulator for fractured-vuggy structure modeling of the rock; obtain the physical property parameters of the carbonate reservoir and the fluid property parameters of the fluid during geological storage; input the parameters to the multi-scale multi-phase flow numerical model to obtain the saturation distribution of CO₂ in the models of difference scales after the completion of injection and the multi-scale CO₂ storage efficiency; evaluate the physical structural storage of CO₂ by using the multi-scale numerical simulation result and the macro mathematical model; directly evaluate the physical residual storage of CO₂ by using the numerical model; directly evaluate the chemical storage of CO₂ by using the empirical model; and predict the chemical mineralization storage of CO₂ by the empirical model. In practical use, firstly, the three-dimensional scanned image of the fractured-vuggy carbonate rock sample including the fracture and hole information is obtained for fractured-vuggy structure modeling and numerical simulation of the rock; the numerical simulation result, the geological exploration data, the development and production information, and storage construction parameters are substituted into the macro analytical model and the experimental empirical model. Thus, not only can the complex fractured-vuggy structure and high mineralization reaction activity of the fractured-vuggy carbonate reservoir be taken into full consideration, but also the field actual parameters can be directly used for calculation of storage amounts under different geological trapping mechanisms.

In this specification, the description of “one embodiment”, “some embodiments”, “an example”, “a specific example” and “some examples” means that a specific feature, structure, material or characteristic described in combination with the embodiment(s) or example(s) is included in at least one embodiment or example of the present disclosure. In this specification, the schematic expression of the above terms is not necessarily directed to the same embodiment or example. Moreover, the specific features, structures, materials, or characteristics described may be combined in a suitable manner in any one or more embodiments or examples. In addition, those skilled in the art may combine different embodiments or examples described in this specification and characteristics of the different embodiments or examples without any contradiction.

In addition, the terms “first” and “second” are merely intended for a purpose of description, and shall not be understood as an indication or implication of relative importance or implicit indication of a quantity of indicated technical features. Therefore, a feature limited by “first” or “second” may explicitly or implicitly include at least one such feature. In the descriptions about the present disclosure, “a plurality of” means at least two, for example, two or three, unless otherwise specifically limited.

What is claimed is:

1. A method for evaluating a geological storage amount of carbon dioxide (CO₂) in a fractured-vuggy carbonate reservoir, comprising the following steps:
performing image identification on a three-dimensional scanned image of a rock sample to obtain identified rock information;
inputting the identified rock information to a computational fluid dynamics-based numerical simulator for constructing a fractured-vuggy rock structure model and obtaining geometric topological information of the rock sample based on the fractured-vuggy rock structure model;
inputting relevant parameters of the rock sample and the geometric topological information to a multi-scale multi-phase flow numerical model for numerical simulation of multi-phase flow migration of CO₂ in models of different scales and obtaining a multi-scale numerical simulation result; and
calculating a multi-scale CO₂ storage efficiency based on the multi-scale numerical simulation result.

2. The method according to claim 1,
wherein the rock sample comprises a fractured-vuggy carbonate reservoir rock sample; and
wherein the relevant parameters of the rock sample comprise physical property parameters of the fractured-vuggy carbonate reservoir and fluid property parameters of a fluid during geological storage.

3. The method according to claim 2, wherein performing image identification on a three-dimensional scanned image of a rock sample to obtain identified rock information comprises:
converting the three-dimensional scanned image into a binary image, and reading a data matrix of the binary image;
mapping the data matrix of the binary image to a red, green, blue (RGB) color value matrix to obtain a first visualization result; and
obtaining a final data matrix based on a result of a comparison between the first visualization result and the three-dimensional scanned image in a topological geometry and a second visualization result of the fluid on the three-dimensional scanned image.

4. The method according to claim 3, wherein the converting the three-dimensional scanned image into a binary image comprises:
extruding a color channel of the three-dimensional scanned image by using a weighted average method to obtain a gray level; and
comparing the gray level with a gray level threshold to obtain a binarized image based on a numerical comparison result.

5. The method according to claim 1, wherein the inputting relevant parameters of the rock sample and the geometric topological information to a multi-scale multi-phase flow numerical model for numerical simulation of multi-phase flow migration of CO₂ in models of different scales and obtaining a multi-scale numerical simulation result comprises:
solving a micro continuity equation based on a Darcy-Brinkman formula by a numerical simulation method to construct the multi-scale multi-phase flow numerical model; and
inputting the physical property parameters, the fluid property parameters, and the geometric topological information to the multi-scale multi-phase flow numerical model for multi-phase flow migration numerical simulation of CO₂ in the models of different scales and obtaining the multi-scale numerical simulation result of a saturation distribution of CO₂ after injection.

6. The method according to claim 5,
wherein the micro continuity equation comprises single-phase and multi-phase micro continuity equations based on mass conservation and single-phase and multi-phase micro continuity equations based on momentum conservation;
wherein the numerical simulation method comprises a finite volume method;
wherein the multi-scale multi-phase flow numerical model comprises a fluid volume method and an implicit Euler difference algorithm; and
wherein the method further comprises:
discretizing the single-phase and multi-phase micro continuity equations based on mass conservation using the finite volume method based on a volume average operator to obtain discretized data;
discretizing a fluid domain into at least one control volume unit based on the fluid volume method, and describing a distribution of the fluid by calculating a volume fraction of a fluid phase in each control volume unit, wherein the volume fraction in each control volume unit represents a volume proportion of a particular fluid phase in the control volume unit; and
expressing the discretized data as data in a semi-discrete form using the implicit Euler difference algorithm.

7. The method according to claim 6, wherein calculating a multi-scale CO₂ storage efficiency based on the multi-scale numerical simulation result comprises obtaining a storage volume of CO₂ by means of the saturation distribution and calculating a fluid injection volume and a CO₂ storage efficiency based on the storage volume of CO₂ and a fluid volume conservation rule to obtain the multi-scale CO₂ storage efficiency.

8. The method according to claim 7, wherein the obtaining a storage volume of CO₂ by means of the saturation distribution and calculating a fluid injection volume and a CO₂ storage efficiency based on the storage volume and a fluid volume conservation rule to obtain the multi-scale CO₂ storage efficiency comprises:
obtaining, by means of numerical simulation, a saturation distribution of CO₂ corresponding to each control volume unit, and obtaining the storage volume of CO₂ based on a first calculation formula;
calculating a volume of injected CO₂ by a second calculation formula based on the fluid volume conservation rule; and
based on the storage volume of CO₂ and the volume of injected CO₂, calculating the CO₂ storage efficiency by a third calculation formula.

9. The method according to claim 7, further comprising:
evaluating a physical structural storage efficiency of CO₂ by using the multi-scale numerical simulation result and a macro mathematical model;
evaluating a physical residual storage efficiency of CO₂ by an empirical model;
evaluating a chemical dissolution storage efficiency of CO₂ by the empirical model; and
evaluating a chemical mineralization storage efficiency of CO₂ by a numerical model.

10. The method according to claim 9, wherein the evaluating a physical structural storage efficiency of CO₂ by using the multi-scale numerical simulation result and a macro mathematical model comprises:
obtaining first fractured-vuggy carbonate reservoir parameters, wherein the first fractured-vuggy carbonate reservoir parameters comprise a geological reserve parameter and a development and production parameter of reservoir crude oil, a geological reserve parameter and a development and production parameter of reservoir natural gas, a three-dimensional volume engraving parameter of a fractured-vuggy body in the fractured-vuggy carbonate reservoir, and a hydraulic fracturing reservoir reformation parameter of an induced fracture in the fractured-vuggy carbonate reservoir; and
inputting the first fractured-vuggy carbonate reservoir parameters and the CO₂ storage efficiency calculated based on a multi-scale simulation result to an analytical model improved based on an evaluation formula of Carbon Storage Leadership Forum (CSLF) to evaluate a total structural storage amount of CO₂.

11. The method according to claim 9, wherein the evaluating a physical residual storage efficiency of CO₂ by an empirical model comprises:
obtaining second fractured-vuggy carbonate reservoir parameters, wherein the second fractured-vuggy carbonate reservoir parameters comprise a reservoir dimensional parameter of the fractured-vuggy carbonate reservoir, a volume proportion of carbonate rock immersed by water in a saturated state of CO₂, a carbonate reservoir porosity, and a CO₂ saturation range under a capillary hysteresis effect;
calculating a volume of carbonate rock immersed by water in the saturated state of CO₂ using the volume proportion of carbonate rock immersed by water in the saturated state of CO₂ and the reservoir dimensional parameter; and
inputting the volume of carbonate rock immersed by water in the saturated state of CO₂, the carbonate reservoir porosity, and the CO₂ saturation range under the capillary hysteresis effect to an empirical model of a residual storage experiment to evaluate a total residual storage amount of CO₂.

12. The method according to claim 9, wherein the evaluating a chemical dissolution storage efficiency of CO₂ by the empirical model comprises:
obtaining third fractured-vuggy carbonate reservoir parameters, wherein the third fractured-vuggy carbonate reservoir parameters comprise a molar solubility at which CO₂ reaches an equilibrium state when dissolved in crude oil, a relative molecular mass of CO₂, an initial crude oil saturation of the carbonate reservoir, a formation water density in the saturated state of CO₂, an average mass fraction of CO₂ in the saturated state in formation water, and a mass fraction and an average molecular weight of hydrocarbons;
substituting the molar solubility at which CO₂ reaches the equilibrium state when dissolved in crude oil and the relative molecular mass of CO₂ into an empirical model of a CO₂ dissolution storage experiment in carbonate reservoir residual oil to evaluate a total dissolution storage amount of CO₂ in reservoir residual oil; and
inputting the initial crude oil saturation of the carbonate reservoir, the formation water density in the saturated state of CO₂, the average mass fraction of CO₂ in the saturated state in formation water, and the mass fraction and the average molecular weight of hydrocarbons to an empirical model of a CO₂ dissolution storage experiment in carbonate reservoir formation water to evaluate a total dissolution storage amount of CO₂ in reservoir formation water.

13. The method according to claim 9, wherein the evaluating a chemical mineralization storage efficiency of CO₂ by a numerical model comprises:
obtaining fourth fractured-vuggy carbonate reservoir parameters, wherein the fourth fractured-vuggy carbonate reservoir parameters comprise a fractured-vuggy carbonate reservoir salinity, a component proportion of mineral composition of fractured-vuggy carbonate rock, a reservoir solution ion concentration, a CO₂ injection rate during carbon storage, and a time of CO₂ mineralization storage; and
inputting the fourth fractured-vuggy carbonate reservoir parameters and the reservoir dimensional parameter to a simulator with a hydrogeochemical module to calculate a final CO₂ mineralization storage amount by numerical simulation.
